(19) United States
(12) Patent Application Publication
(10) Pub. No.: US 2024/0414435 A1
(43) Pub. Date: Dec. 12, 2024

(54) INTERLEAVED PROCESSING OF IMAGE DATA

(71) Applicant: QUALCOMM Incorporated, San Diego, CA (US)

(72) Inventors: Mei YANG, San Diego, CA (US); Vinod Kumar NAHVAL, Mountain House, CA (US)

(21) Appl. No.: 18/330,192

(22) Filed: Jun. 6, 2023

(51) Int. Cl. H04N 23/60

(52) U.S. Cl. CPC H04N 23/665

(57) ABSTRACT

Systems and techniques are described herein for processing image data. For instance, a method for processing image data is provided. The method may include receiving first image data related to a first image at an image-signal processor (ISP); receiving second image data related to a second image at the ISP; while receiving the first image data and the second image data, processing the first image data and the second image data at the ISP; and in response to receiving a last portion of the first image data, delaying flushing of the first image data from an internal buffer of the ISP while processing the second image data.

### TECHNICAL FIELD

The present disclosure generally relates to processing image data. In some examples, aspects of the present disclosure are related to processing image data in an interleaved manner.

### BACKGROUND

A camera may focus light onto an image sensor that may generate image data representative of the light. The image data may represent images, such as still images and/or video frames. Image signal processors (ISPs) may receive image data (e.g., raw image data from an image sensor) and process the image data, for example, to perform operations related to, as examples, Bayer transformations, demosaicing, noise reduction, and/or image sharpening.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for processing image data. According to at least one example, a method is provided for processing image data. The method includes: receiving first image data related to a first image at an image-signal processor (ISP); receiving second image data related to a second image at the ISP; while receiving the first image data and the second image data, processing the first image data and the second image data at the ISP; and in response to receiving a last portion of the first image data, delaying flushing of the first image data from an internal buffer of the ISP while processing the second image data.

In another example, an apparatus for processing image data is provided that includes at least one memory and at least one processor (e.g., configured in circuitry) coupled to the at least one memory. The at least one processor configured to: receive first image data related to a first image at an image-signal processor (ISP); receive second image data related to a second image at the ISP; while receiving the first image data and the second image data, process the first image data and the second image data at the ISP; and in response to receiving a last portion of the first image data, delay flushing of the first image data from an internal buffer of the ISP while processing the second image data.

In another example, a non-transitory computer-readable medium is provided that has stored thereon instructions that, when executed by one or more processors, cause the one or more processors to: receive first image data related to a first image at an image-signal processor (ISP); receive second image data related to a second image at the ISP; while receiving the first image data and the second image data, process the first image data and the second image data at the ISP; and in response to receiving a last portion of the first image data, delay flushing of the first image data from an internal buffer of the ISP while processing the second image data.

In another example, an apparatus for processing image data is provided. The apparatus includes: means for receiving first image data related to a first image at an image-signal processor (ISP); means for receiving second image data related to a second image at the ISP; means for, while receiving the first image data and the second image data, processing the first image data and the second image data at the ISP; and means for, in response to receiving a last portion of the first image data, delaying flushing of the first image data from an internal buffer of the ISP while processing the second image data.

In another example, a method is provided for processing image data. The method includes: receiving first image data related to a first image at an image-signal processor (ISP); receiving second image data related to a second image at the ISP; while receiving the first image data and the second image data, processing the first image data and the second image data at the ISP; and in response to receiving a last portion of the first image data, buffering the second image data while flushing the first image data from an internal buffer of the ISP.

In another example, an apparatus for processing image data is provided that includes at least one memory and at least one processor (e.g., configured in circuitry) coupled to the at least one memory. The at least one processor configured to: receive first image data related to a first image at an image-signal processor (ISP); receive second image data related to a second image at the ISP; while receiving the first image data and the second image data, process the first image data and the second image data at the ISP; and in response to receiving a last portion of the first image data, buffer the second image data while flushing the first image data from an internal buffer of the ISP.

In another example, a non-transitory computer-readable medium is provided that has stored thereon instructions that, when executed by one or more processors, cause the one or more processors to: receive first image data related to a first image at an image-signal processor (ISP); receive second image data related to a second image at the ISP; while receiving the first image data and the second image data, process the first image data and the second image data at the ISP; and in response to receiving a last portion of the first image data, buffer the second image data while flushing the first image data from an internal buffer of the ISP.

In another example, an apparatus for processing image data is provided. The apparatus includes: means for receiving first image data related to a first image at an image-signal processor (ISP); means for receiving second image data related to a second image at the ISP; means for, while receiving the first image data and the second image data, processing the first image data and the second image data at the ISP; and means for, in response to receiving a last portion of the first image data, buffering the second image data while flushing the first image data from an internal buffer of the ISP.

In some aspects, one or more of the apparatuses described herein is, is part of, and/or includes a mobile device (e.g., a mobile telephone and/or mobile handset and/or so-called “smartphone” or other mobile device), a camera, an extended reality (XR) device (e.g., a virtual reality (VR) device, an augmented reality (AR) device, or a mixed reality (MR) device), a head-mounted device (HMD) device, a camera (e.g., an internet protocol (IP) camera, a surveillance camera, etc.), a vehicle or a computing system of the vehicle, device, or component of a vehicle, a wearable device (e.g., a network-connected watch or other wearable device), a wireless communication device, a personal computer, a laptop computer, a server computer, another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensors).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a block diagram illustrating an example architecture of an image-processing system, according to various aspects of the present disclosure.

FIG. 2 illustrates a block diagram illustrating an example system including an image sensor and an image processor, according to various aspects of the present disclosure.

FIG. 3 illustrates multiple images, captured with different image-capture parameters, and used to create a composite image, according to various aspects of the present disclosure.

FIG. 4 illustrates a block diagram illustrating an example system including an image processor, an image sensor, and an image sensor, according to various aspects of the present disclosure.

FIG. 5 is a perspective diagram illustrating an example vehicle that includes multiple cameras, according to various aspects of the present disclosure.

FIG. 6 is a block diagram illustrating an example system, which may be an image processor, according to various aspects of the present disclosure.

FIG. 7 is a block diagram illustrating example portions of sets of image data that may be provided to an image processor in an interleaved manner.

FIG. 8 is a block diagram illustrating an example system, which may be an image processor, according to various aspects of the present disclosure.

FIG. 9 is a block diagram illustrating another example system, which may be an image processor, according to various aspects of the present disclosure.

FIG. 10 is a block diagram illustrating another example system, which may be an image processor, according to various aspects of the present disclosure.

FIG. 11 is a flow diagram illustrating an example process for processing image data, in accordance with aspects of the present disclosure.

FIG. 12 is a flow diagram illustrating an example process for processing image data, in accordance with aspects of the present disclosure.

FIG. 13 illustrates an example computing-device architecture 1300 of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and descriptions are not intended to be restrictive.

The ensuing description provides example aspects only and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As mentioned above, an image sensor may generate image data and an image signal processor (ISP) may process the image data. An ISP may receive and process multiple sets of image data. As an example, an ISP may receive respective sets of image data from two or more image sensors. For example, an ISP in an vehicle computing system may receive image data from a number of image sensors of the vehicle. As another example, a single image sensor may provide an image sensor with multiple sets of image data. For example, an image sensor may capture short-exposure image data and long-exposure image data and may provide both to an ISP.

In some cases, an ISP may receive and process sets of image data serially. For example, the ISP may process one set of image data entirely before processing a second set of image data. In other cases, some ISPs may be configured to receive and process two or more sets of image data in an interleaved manner. For example, such an ISP may be configured to receive a portion of first image data (e.g., one or more lines of a first image) to store the portion of the first image data in a first internal buffer, to process the portion of the first image, and to output a processed portion of the first image data (e.g., one or more processed lines of the first image). Following the outputting of the processed portion of the first image data, and before receiving another portion of the first image data, the ISP may be configured to receive and process a portion of second image data. For example, the ISP may be configured to receive a portion of second image data (e.g., one or more lines of a second image) to store the portion of the second image data in a second internal buffer, to process the portion of the second image, and to output a processed portion of the second image data (e.g., one or more processed lines of the second image). Following the outputting of the processed portion of the second image data, and before receiving another portion of the second image data, the ISP may be configured to receive and process a portion of third image data or a portion of the first image data.

Using a single ISP to process image data from multiple image sensors (or to process multiple sets of image data from a single sensor) may conserve space in devices or systems compared with other systems that include one ISP per image sensors (or one ISP per type of image data captured by an image sensor). An ISP that can process data from multiple image sensors May conserve space compared with an integrated circuit with one ISP for each image sensor (or for each type of image data).

In some cases, processing sets of image data by an ISP in an interleaved manner may rely on a provider of the image data. For example, the provider may provide the sets of image data in an interleaved manner (e.g., interleaving portions from respective sets of image data) and the ISP may operate on the image data as the image data is received. One challenge to such approaches is that when an ISP receives a last portion of a set of image data (e.g., a last line of an image), the ISP may, by default, flush all data related to the set of image data from an internal buffer of the ISP. Flushing may include processing and/or outputting processed data based on data related to the set of image data that is remining in the internal buffer. Such flushing may conflict with the processing of other sets of image data being received by the ISP. For example, while an ISP flushes data related to a first set of image data, the ISP may receive a portion of a second set of image data. Receiving the portion of the second set of image data to process while flushing data related to the first set of image data may be a conflict and the ISP may not be able to both flush the data related to the first set of image data and receive and/or process the portion of the second set of image data at the same time.

Systems, apparatuses, methods (also referred to as processes), and computer-readable media (collectively referred to herein as “systems and techniques”) are described herein for processing interleaved image data. In some aspects, the systems and techniques may include a buffer to store incoming data while other data is being flushed. In some aspects, the systems and techniques may include a flushing scheduler to delay flushing so that the flushing does not conflict with processing of other data. In some aspects, the systems and techniques may include both a buffer and a flushing scheduler.

The systems and techniques may enable systems and devices to use one ISP to process interleaved image data from multiple image sensors (or multiple types of image data from a single image sensor) without conflicts. The systems and techniques may enable systems or devices to conserve space by including fewer ISPs than other systems or devices.

Various aspects of the systems and techniques are described herein and will be discussed below with respect to the figures.

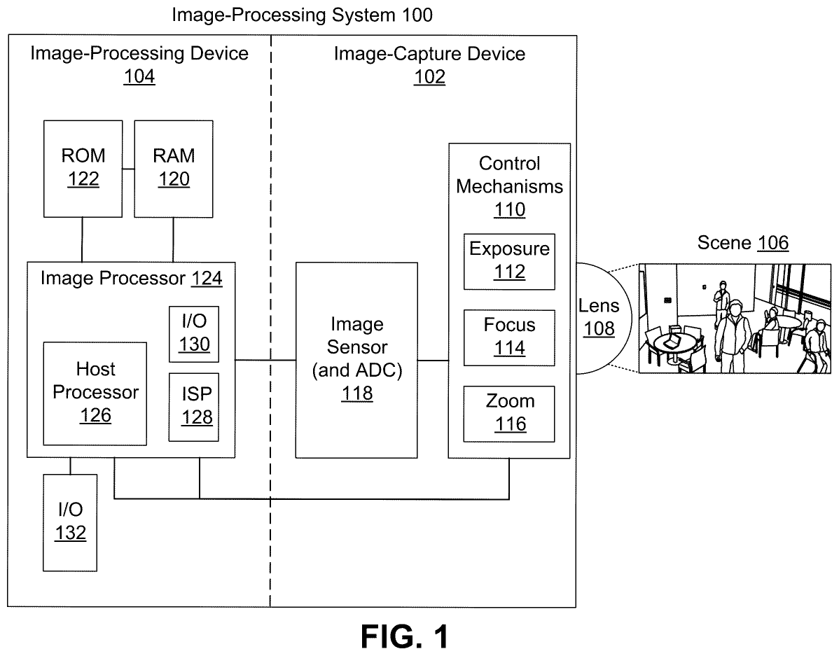

FIG. 1 is a block diagram illustrating an example architecture of an image-processing system 100, according to various aspects of the present disclosure. The image-processing system 100 includes various components that are used to capture and process images, such as an image of a scene 106. The image-processing system 100 can capture image frames (e.g., still images or video frames). In some cases, the lens 108 and image sensor 118 (which may include an analog-to-digital converter (ADC)) can be associated with an optical axis. In one illustrative example, the photosensitive area of the image sensor 118 (e.g., the photodiodes) and the lens 108 can both be centered on the optical axis.

In some examples, the lens 108 of the image-processing system 100 faces a scene 106 and receives light from the scene 106. The lens 108 bends incoming light from the scene toward the image sensor 118. The light received by the lens 108 then passes through an aperture of the image-processing system 100. In some cases, the aperture (e.g., the aperture size) is controlled by one or more control mechanisms 110. In other cases, the aperture can have a fixed size.

The one or more control mechanisms 110 can control exposure, focus, and/or zoom based on information from the image sensor 118 and/or information from the image processor 124. In some cases, the one or more control mechanisms 110 can include multiple mechanisms and components. For example, the control mechanisms 110 can include one or more exposure-control mechanisms 112, one or more focus-control mechanisms 114, and/or one or more zoom-control mechanisms 116. The one or more control mechanisms 110 may also include additional control mechanisms besides those illustrated in FIG. 1. For example, in some cases, the one or more control mechanisms 110 can include control mechanisms for controlling analog gain, flash, HDR, depth of field, and/or other image capture properties.

The focus-control mechanism 114 of the control mechanisms 110 can obtain a focus setting. In some examples, focus-control mechanism 114 stores the focus setting in a memory register. Based on the focus setting, the focus-control mechanism 114 can adjust the position of the lens 108 relative to the position of the image sensor 118. For example, based on the focus setting, the focus-control mechanism 114 can move the lens 108 closer to the image sensor 118 or farther from the image sensor 118 by actuating a motor or servo (or other lens mechanism), thereby adjusting the focus. In some cases, additional lenses may be included in the image-processing system 100. For example, the image-processing system 100 can include one or more microlenses over each photodiode of the image sensor 118. The microlenses can each bend the light received from the lens 108 toward the corresponding photodiode before the light reaches the photodiode.

In some examples, the focus setting may be determined via contrast detection autofocus (CDAF), phase detection autofocus (PDAF), hybrid autofocus (HAF), or some combination thereof. The focus setting may be determined using the control mechanism 110, the image sensor 118, and/or the image processor 124. The focus setting may be referred to as an image capture setting and/or an image processing setting. In some cases, the lens 108 can be fixed relative to the image sensor and the focus-control mechanism 114.

The exposure-control mechanism 112 of the control mechanisms 110 can obtain an exposure setting. In some cases, the exposure-control mechanism 112 stores the exposure setting in a memory register. Based on the exposure setting, the exposure-control mechanism 112 can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 118 (e.g., ISO speed or film speed), analog gain applied by the image sensor 118, or any combination thereof. The exposure setting may be referred to as an image capture setting and/or an image processing setting.

The zoom-control mechanism 116 of the control mechanisms 110 can obtain a zoom setting. In some examples, the zoom-control mechanism 116 stores the zoom setting in a memory register. Based on the zoom setting, the zoom-control mechanism 116 can control a focal length of an assembly of lens elements (lens assembly) that includes the lens 108 and one or more additional lenses. For example, the zoom-control mechanism 116 can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 108 in some cases) that receives the light from the scene 106 first, with the light then passing through an afocal zoom system between the focusing lens (e.g., lens 108) and the image sensor 118 before the light reaches the image sensor 118. The afocal zoom system may, in some cases, include two positive (e.g., converging, convex) lenses of equal or similar focal length (e.g., within a threshold difference of one another) with a negative (e.g., diverging, concave) lens between them. In some cases, the zoom-control mechanism 116 moves one or more of the lenses in the afocal zoom system, such as the negative lens and one or both of the positive lenses. In some cases, zoom-control mechanism 116 can control the zoom by capturing an image from an image sensor of a plurality of image sensors (e.g., including image sensor 118) with a zoom corresponding to the zoom setting. For example, the image-processing system 100 can include a wide-angle image sensor with a relatively low zoom and a telephoto image sensor with a greater zoom. In some cases, based on the selected zoom setting, the zoom-control mechanism 116 can capture images from a corresponding sensor.

The image sensor 118 includes one or more arrays of photodiodes or other photosensitive elements. Each photodiode measures an amount of light that eventually corresponds to a particular pixel in the image produced by the image sensor 118. In some cases, different photodiodes may be covered by different filters. In some cases, different photodiodes can be covered in color filters, and may thus measure light matching the color of the filter covering the photodiode. Various color filter arrays can be used such as, for example and without limitation, a Bayer color filter array, a quad color filter array (QCFA), and/or any other color filter array.

In some cases, the image sensor 118 may alternately or additionally include opaque and/or reflective masks that block light from reaching certain photodiodes, or portions of certain photodiodes, at certain times and/or from certain angles. In some cases, opaque and/or reflective masks may be used for phase detection autofocus (PDAF). In some cases, the opaque and/or reflective masks may be used to block portions of the electromagnetic spectrum from reaching the photodiodes of the image sensor (e.g., an IR cut filter, a UV cut filter, a band-pass filter, low-pass filter, high-pass filter, or the like). The image sensor 118 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 110 may be included instead or additionally in the image sensor 118. The image sensor 118 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

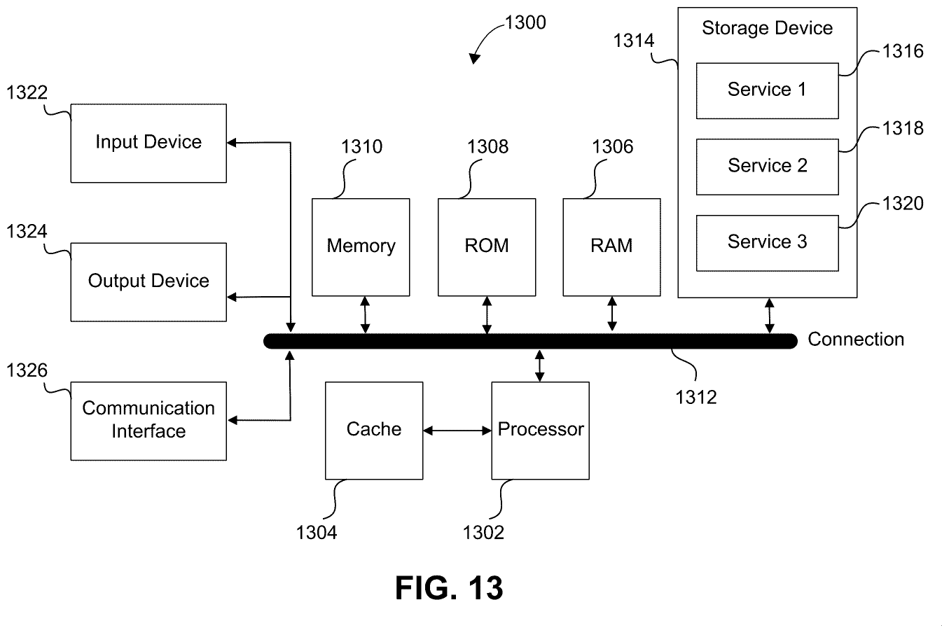

The image processor 124 may include one or more processors, such as one or more image signal processors (ISPs) (including ISP 128), one or more host processors (including host processor 126), and/or one or more of any other type of processor discussed with respect to the computing-device architecture 1300 of FIG. 13. The host processor 126 can be a digital signal processor (DSP) and/or other type of processor. In some implementations, the image processor 124 is a single integrated circuit or chip (e.g., referred to as a system-on-chip or SoC) that includes the host processor 126 and the ISP 128. In some cases, the chip can also include one or more input/output ports (e.g., input/output (I/O) ports 130), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 130 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 126 can communicate with the image sensor 118 using an I2C port, and the ISP 128 can communicate with the image sensor 118 using an MIPI port.

The image processor 124 may perform a number of tasks, such as de-mosaicing, color space conversion, image frame downsampling, pixel interpolation, automatic exposure (AE) control, automatic gain control (AGC), CDAF, PDAF, automatic white balance, combining of image frames to form a composite image (e.g., an HDR image), image recognition, object recognition, feature recognition, receipt of inputs, managing outputs, managing memory, or some combination thereof. The image processor 124 may store image frames and/or processed images in random-access memory (RAM) 120, read-only memory (ROM) 122, a cache, a memory unit, another storage device, or some combination thereof.

Various input/output (I/O) devices 132 may be connected to the image processor 124. The I/O devices 132 can include a display screen, a keyboard, a keypad, a touchscreen, a trackpad, a touch-sensitive surface, a printer, any other output devices, any other input devices, or any combination thereof. In some cases, a caption may be input into the image-processing device 104 through a physical keyboard or keypad of the I/O devices 132, or through a virtual keyboard or keypad of a touchscreen of the I/O devices 132. The I/O devices 132 may include one or more ports, jacks, or other connectors that enable a wired connection between the image-processing system 100 and one or more peripheral devices, over which the image-processing system 100 may receive data from the one or more peripheral device and/or transmit data to the one or more peripheral devices. The I/O devices 132 may include one or more wireless transceivers that enable a wireless connection between the image-processing system 100 and one or more peripheral devices, over which the image-processing system 100 may receive data from the one or more peripheral device and/or transmit data to the one or more peripheral devices. The peripheral devices may include any of the previously-discussed types of the I/O devices 132 and may themselves be considered I/O devices 132 once they are coupled to the ports, jacks, wireless transceivers, or other wired and/or wireless connectors.

In some cases, the image-processing system 100 may be a single device. In some cases, the image-processing system 100 may be two or more separate devices, including an image-capture device 102 (e.g., a camera) and an image-processing device 104 (e.g., a computing device coupled to the camera). In some implementations, the image-capture device 102 and the image-capture device 102 may be coupled together, for example via one or more wires, cables, or other electrical connectors, and/or wirelessly via one or more wireless transceivers. In some implementations, the image-capture device 102 and the image-processing device 104 may be disconnected from one another. In some cases, image-processing system 100 may include one image-processing device 104 (e.g., as illustrated in FIG. 1). In other cases, image-processing system 100 may include two or more image-capture devices 102 that may generate image data and provide the image data to a single image-processing device 104.

As shown in FIG. 1, a vertical dashed line divides the image-processing system 100 of FIG. 1 into two portions that represent the image-capture device 102 and the image-processing device 104, respectively. The image-capture device 102 includes the lens 108, control mechanisms 110, and the image sensor 118. The image-processing device 104 includes the image processor 124 (including the ISP 128 and the host processor 126), the RAM 120, the ROM 122, and the I/O device 132. In some cases, certain components illustrated in the image-capture device 102, such as the ISP 128 and/or the host processor 126, may be included in the image-capture device 102. In some examples, the image-processing system 100 can include one or more wireless transceivers for wireless communications, such as cellular network communications, 802.11 wi-fi communications, wireless local area network (WLAN) communications, or some combination thereof.

The image-processing system 100 can be part of, or implemented by, a single computing device or multiple computing devices. In some examples, the image-processing system 100 can be part of an electronic device (or devices) such as a camera system (e.g., a digital camera, an IP camera, a video camera, a security camera, etc.), a vehicle computing system, a telephone system (e.g., a smartphone, a cellular telephone, a conferencing system, etc.), a laptop or notebook computer, a tablet computer, a set-top box, a smart television, a display device, a game console, an XR device (e.g., an HMD, smart glasses, etc.), an IoT (Internet-of-Things) device, a smart wearable device, a video streaming device, an Internet Protocol (IP) camera, or any other suitable electronic device(s).

While the image-processing system 100 is shown to include certain components, one of ordinary skill will appreciate that the image-processing system 100 can include more components than those shown in FIG. 1. The components of the image-processing system 100 can include software, hardware, or one or more combinations of software and hardware. For example, in some implementations, the components of the image-processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image-processing system 100.

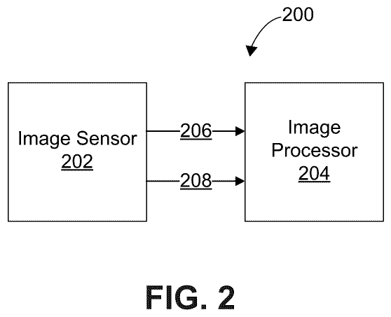

In some examples image-capture device 102 may generate multiple sets of image data for processing by image-processing device 104. For example, FIG. 2 illustrates a block diagram illustrating an example system 200 including an image sensor 202 and an image processor 204, according to various aspects of the present disclosure. Image sensor 202 may be an example of image-capture device 102 of FIG. 1 or of image sensor 118 of FIG. 1. Image processor 204 may be an example of image-processing device 104 of FIG. 1 or of image processor 124 of FIG. 1. Image sensor 202 may generate image data 206 and image data 208 and provide both image data 206 and image data 208 to image processor 204. Image processor 204 may process both image data 206 and image data 208. Image processor 204 may process image data 206 and image data 208 in an interleaved manner.

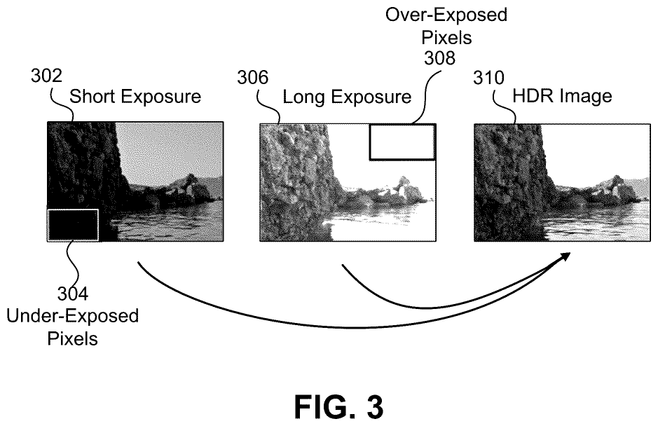

FIG. 3 illustrates multiple example images, captured by a single image sensor, with different image-capture parameters, and used to create a composite image 310, according to various aspects of the present disclosure. In particular, FIG. 3 shows a short-exposure image 302, a long-exposure image 306, and composite image 310. Composite image 310 may be generated by combining portions of the short-exposure image 302 and portions of the long-exposure image 306. The short-exposure image 302 includes under-exposed pixels 304, and the long-exposure image 306 includes over-exposed pixels 308. As shown in FIG. 3, composite image 310 includes pixels from short-exposure image 302, but not under-exposed pixels 304, and pixels from long-exposure image 306, but not over-exposed pixels 308.

Short-exposure image 302 and long-exposure image 306 (or image data representing short-exposure image 302 and long-exposure image 306 respectively) may be captured by the same image sensor (e.g., image sensor 118 of image-capture device 102 of FIG. 1 or image processor 204 of FIG. 2). Further, short-exposure image 302 and long-exposure image 306 (or image data representing short-exposure image 302 and long-exposure image 306 respectively) may both be provided to the same ISP (e.g., image processor 124 of image-processing device 104 of FIG. 1 or image processor 204 of FIG. 2). The ISP may process both short-exposure image 302 and long-exposure image 306. In some cases, the ISP may generate composite image 310 based on short-exposure image 302 and long-exposure image 306.

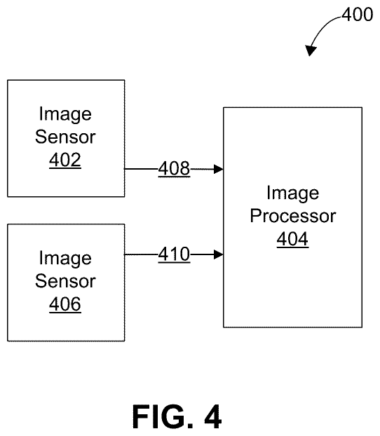

In some cases, an image process or may process image data from two or more image sensors. For example, FIG. 4 illustrates a block diagram illustrating an example system 400 including an image processor 404, an image sensor 402, and an image sensor 406, according to various aspects of the present disclosure. Image sensor 402 and/or image sensor 406 may be examples of image-capture device 102 of FIG. 1 or of image sensor 118 of FIG. 1. Image processor 404 may be an example of image-processing device 104 of FIG. 1 or of image processor 124 of FIG. 1. Image sensor 402 may generate image data 408 and provide image data 408 to image processor 404. Image sensor 406 may generate image data 410 and provide image data 410 to image processor 404. Image processor 404 may process image data 408 from image sensor 402 and image data 410 from image sensor 406. Image processor 404 may process image data 408 and image data 410 in an interleaved manner.

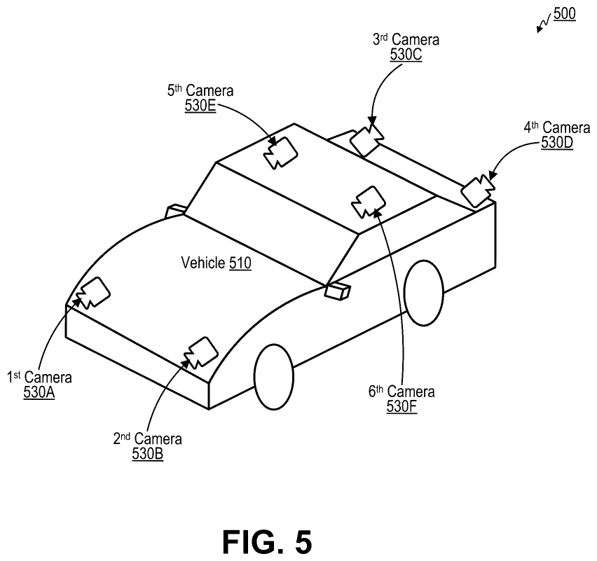

As an example, FIG. 5 is a perspective diagram 500 illustrating a vehicle 510 that includes multiple cameras, according to various aspects of the present disclosure. Vehicle 510 may include one or more instances of imaging system 100 of FIG. 1. Additionally, or alternatively, vehicle 510 may include multiple image-capture devices 102 and multiple image-processing devices 104 (e.g., fewer image-processing devices 104 than image-capture devices 102). Vehicle 510 may be, for example, an automobile, a truck, a bus, a train, a ground-based vehicle, an airplane, a helicopter, an aircraft, an aerial vehicle, a boat, a submarine, a watercraft, an underwater vehicle, a hovercraft, or a combination thereof. In some examples, vehicle 510 may be manned. In some examples, vehicle 510 may be unmanned, autonomous, and/or semi-autonomous. In some examples, the vehicle may be at least partially controlled and/or used with sub-systems of vehicle 510, such as advance driver assistance system (ADAS) of vehicle 510, in-vehicle infotainment (IVI) systems of the vehicle 510, autonomous driving systems of the vehicle 510, semi-autonomous driving systems of the vehicle 510, a vehicle electronic control unit (ECU) of vehicle 510, or a combination thereof.

Vehicle 510 includes a first camera 530A and a second camera 530B at the front, a third camera 530C and a fourth camera 530D at the rear, and a fifth camera 530E and a sixth camera 530F on the top. First camera 530A, a second camera 530B, third camera 530C, fourth camera 530D, a fifth camera 530E, and a sixth camera 530F may be referred to collectively as cameras 530. In some examples, vehicle 510 may include additional cameras in addition to the cameras illustrated in FIG. 5. In some examples, vehicle 510 may be missing some of the cameras that are illustrated in FIG. 5.

Any of all of the cameras 530 may provide image data (e.g., raw image data and/or partially processed image data) to one or more ISPs. In some cases, two or more of cameras 530 may provide image data to one ISP. For example, in some cases, all of cameras 530 may provide image data to a single ISP. As another example, first camera 530A and second camera 530B may provide image data to a first ISP, third camera 530C and fourth camera 530D may provide image data to a second ISP, and fifth camera 530E and sixth camera 530F may provide image data to a third ISP.

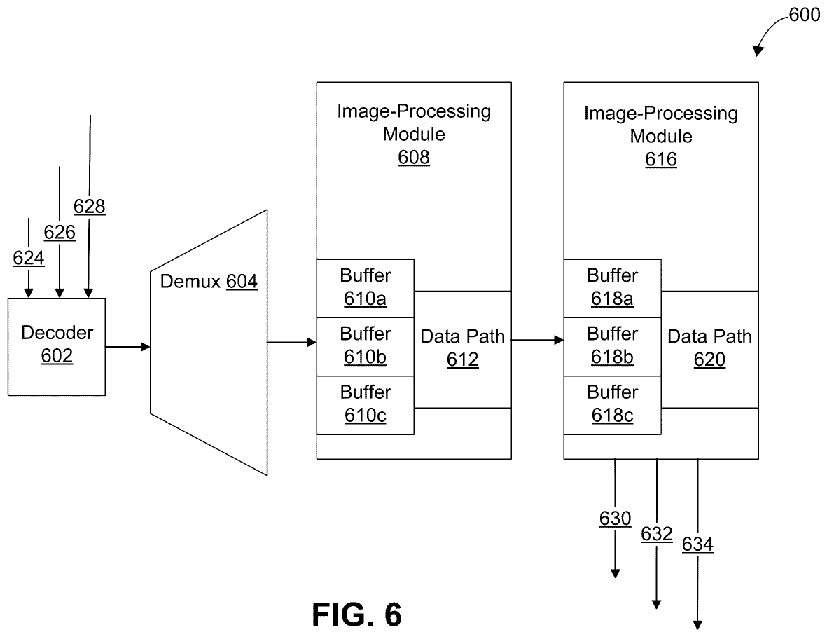

FIG. 6 is a block diagram illustrating an example system 600, which may be an image processor, according to various aspects of the present disclosure. System 600 may be an example of image processor 124 of FIG. 1, ISP 128 of FIG. 1, image processor 204 of FIG. 2, and/or image processor 404 of FIG. 4.

System 600 may receive image data from any number of sources (e.g., image sensors). For example, image data 624 may be from a first source, image data 626 may be from a second source, and image data 628 may be from a third source. For example, image data 624 may be from first camera 530A, image data 626 may be from second camera 530B, and image data 628 may be from third camera 530C. Three sources are illustrated and described for simplicity. System 600 may receive any number of sets of image data from any number of sources.

Additionally, or alternatively, system 600 may receive any number of sets of image data from one source (e.g., an image sensor). For example, image data 624 may be a first set of image data from a source, image data 626 may be a second set of image data from the source, and image data 628 may be a third set of image data from the source. For example, image data 624 may be short-exposure image data (e.g., representative of short-exposure image 302), image data 626 may be medium-exposure image data, and image data 628 may be long-exposure image data (e.g., representative of long-exposure image 306).

System 600 may receive image data 624, image data 626, and image data 628 in an interleaved manner. For example, a scheduler or serializer/deserializer (SerDes) may receive image data 624, image data 626, and/or image data 628 from the one or more respective sources and may provide image data 624, image data 626, and image data 628 in an interleaved manner to system 600.

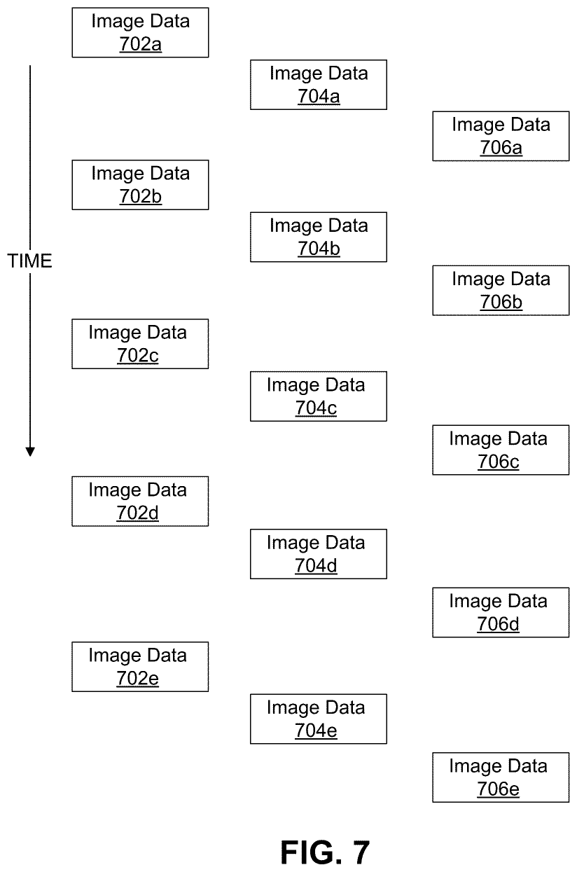

FIG. 7 is a block diagram illustrating portions of image data 702a, 702b, 702c, 702d, 702e (collectively referred to as image data 702), image data 704a, 704b, 704c, 704d, 704c (collectively referred to as image data 704), and image data 706a, 706b, 706c, 706d, 706e (collectively referred to as image data 706) that may be provided to an image processor in an interleaved manner. For example, image data 702 may include image-data portion 702a, image-data portion 702b, image-data portion 702c, image-data portion 702d, and image-data portion 702e. Each of image-data portion 702a, image-data portion 702b, image-data portion 702c, image-data portion 702d, and image-data portion 702e may be a respective portion of image data 702. For example, each of image-data portion 702a, image-data portion 702b, image-data portion 702c, image-data portion 702d, and image-data portion 702e may represent one or more lines of an image represented by image data 702. Similarly, image data 704 may include image-data portion 704a, image-data portion 704b, image-data portion 704c, image-data portion 704d, and image-data portion 704c, each of which may represent one or more lines of image data 704. Image data 706 may include image-data portion 706a, image-data portion 706b, image-data portion 706c, image-data portion 706d, and image-data portion 706e, each of which may represent one or more lines of image data 706. The number of lines included in each of the portions of the respective image data may, or may not, be consistent. For example, image-data portion 702a may include a first number of lines, image-data portion 702b may include a second number of lines. The second number of lines may be the same or may be different from the first number of lines. Image-data portion 702c may include a third number of lines that may be the same or different from the first number of lines and the same or different from the second number of lines.

Three sets of image data (image data 702, image data 704, and image data 706) are illustrated for simplicity. An image processor may receive any number of sets of image data from any number of sources (including from one source). Further, five portions of each of the sets of image data 702, 704, 706 are illustrated for simplicity. A set of image data (e.g., an image) may include any number of portions. For example, where each portion represents a line of an image, a set of image data may include 486, 576, 720, 1080, 2160, 3840, etc. portions. As another example, where each portion represents two lines of an image, a set of image data may include 243, 288, 360, 540, 1080, 1920, etc. portions. As another example, where each portion represents four lines of an image, a set of image data may include 144, 180, 270, 540, 960, etc. portions. However, noted above, the number of lines in each portion may not be consistent in some cases. In such cases, a set of image data may include any number of portions.

Image data 702, image data 704, and image data 706 are illustrated as arranged in time in an interleaved manner. For example, in FIG. 7, time may be represented in the vertical direction. As such, image data 702, image data 704, and image data 706 may be provided to an image processor in an interleaved manner, for example, in the following order, image-data portion 702a. image-data portion 704a, image-data portion 706a, image-data portion 702b, image-data portion 704b, image-data portion 706b, image-data portion 702c, image-data portion 704c, image-data portion 706c, image-data portion 702d, image-data portion 704d, image-data portion 706d, image-data portion 702c, image-data portion 704c, image-data portion 706c.

Image data 702, image data 704, and image data 706 are illustrated as separated in the horizontal direction for illustrative purposes. Image data 702, image data 704, and image data 706 may all be provided to an image processor via a single interface. Similarly, image data 624, image data 626, and image data 628 of FIG. 6 are illustrated separately for descriptive purposes. image data 624, image data 626, and image data 628 may be received by system 600 at a single interface.

Returning to FIG. 6, system 600 may receive and process image data 624, image data 626, and image data 628, in an interleaved manner and generate processed image data 630, processed image data 632, and processed image data 634 in an interleaved manner. For example, system 600 may receive a portion of image data 624 (e.g., data representative of one or more lines of an image represented by image data 624) and may generate a portion of processed image data 630. The portion of processed image data 630 may be data representative of one or more processed lines of an image represented by processed image data 630. Processed image data 630 as a whole may represent image data 624 as processed by system 600. Following the processing of the portion of image data 624, system 600 may receive a portion of image data 626 (e.g., data representative of one or more lines of an image represented by image data 626) and may generate a portion of processed image data 632. Following the processing of the portion of image data 626, system 600 may receive a portion of image data 628 (e.g., data representative of one or more lines of an image represented by image data 628) and may generate a portion of processed image data 634. Following the processing of the portion of image data 628, system 600 may receive another portion of image data 624 and may generate another portion of processed image data 630.

System 600 may include a decoder 602, which may receive image data 624, image data 626, and image data 628. Decoder 602 may decode image data 624, image data 626, and image data 628. For example, decoder 602 may extract data from packets (e.g., removing payload data from data packets including headers and/or trailers).

System 600 may include a demultiplexer 604 (which may also be referred to as demux 604). Demultiplexer 604 may receive image data 624, image data 626, and image data 628 (or payloads of image data 624, image data 626, and image data 628) and provide image data 624, image data 626, and image data 628 to a first of one or more image-processing modules (e.g., image-processing module 608). Demultiplexer 604 may buffer input image data (e.g., decoded image data) and in some cases duplicate image data to generate multiple copies of the image data, then send the copies of the image data to downstream image-processing modules. For example, the same image may need to be processed differently for computer vision and for human vision. Accordingly, the same image may be processed two or more times by the one or more image-processing modules, (e.g., with different configurations). In such cases demultiplexer 604 may duplicate the image data and send the duplicated image data to downstream image-processing modules in an interleaved manner. The downstream image-processing modules may treat such image data as different images (e.g., similar two how the image-processing modules may treat different images sent by different sensors). Demultiplexer 604 is optional in system 600. For example, in some cases, system 600 may not include demultiplexer 604. In such cases, decoder 602 may provide image data (e.g., decoded image data) to image-processing module 608.

Additionally, or alternatively, there may be one or more demultiplexers (not illustrated in FIG. 6) instantiated within each of the image-processing modules. The demultiplexers within the image-processing modules may manage storing image data into buffers. For example, a demultiplexer within image-processing module 608 may store image data 624 in buffer 610a, image data 626 in buffer 610b, and image data 628 in buffer 610c.

System 600 may include one or more image-processing modules. Image-processing module 608 and image-processing module 616 are given as examples. System 600 may include any number of image-processing modules. Each of the image-processing modules may perform one or more image-processing operations on image data, such as, scalar multiplications on pixels, filtering of pixels or groups of pixels, etc. In some cases, the image-processing modules may perform operations on portions of the image data as they are received and without using any other portions of the image data. In other cases, the image-processing modules may perform operations based on multiple portions of the image data. For example, image-processing module 608 may filter image data 624 using a 3×3 or 5×5 finite input response (FIR) filter. In such cases, image-processing module 608 may buffer multiple portions (e.g., 3 lines or 5 lines) of image data 624. Then, when buffer 610a includes the multiple portions of image data, image-processing module 608 may operate on the multiple portions to produce one portion of processed image data 624 and to provide the one portion of processed image data 624 to a subsequent image-processing module (e.g., image-processing module 616). In some cases, buffer 610a, buffer 610b, and buffer 610c (which may be referred to collectively as buffers 610) may store portions of respective image data based on how image-processing module 608 operates on the portions of image data. For example, in cases in which image-processing module 608 operates on 5 lines of image data at a time, buffer 610a may store the 4 most-recently receive portions of image data 624 (e.g., in cases in which each portion includes one line of image data).

As an example of operation of image-processing module 608, image-processing module 608 may receive portions of image data 624, image data 626, and image data 628 in turn and may store received portions of image data 624 in buffer 610a, portions of image data 626 in buffer 610b, and portions of image data 628 in buffer 610c. When there are enough portions of image data 624 in buffer 610a, image-processing module 608 may process newly received portions at data path 612 along with the previously-received portions of image data 624 stored in buffer 610a. Image-processing module 608 may process image data 624 as it is received, conditional on having enough portions of image data 624 stored in buffer 610a. For example, as a portion of image data 624 is received, if there are enough portions of image data 624 in buffer 610a, image-processing module 608 may process image data 624 and output processed image data 624 to image-processing module 616. For example, if image-processing module 608 is to filter five lines of image data 624 at a time, image-processing module 608 may buffer the first four portions of image data 624 (e.g., in cases in which each portion includes one line of image data) and may process all five portions of image data 624 when the fifth portion is received. When the sixth portion of 624 is received, image-processing module 608 may add the sixth portion to buffer 610a (in some cases overwriting the first portion of image data 624) and may process the second through sixth portions of image data 624. Likewise, image-processing module 608 may process image data 626 as it is received, conditional on having enough portions of image data 626 stored in buffer 610b, and image data 628 as it is received, conditional on having enough portions of image data 628 stored in buffer 610c.

Image-processing module 616 may operate in substantially the same manner as image-processing module 608. For example, image-processing module 616 may receive image data 624, image data 626, and image data 628 (as processed by image-processing module 608) and store portions of image data 624, image data 626, and image data 628 as they are received at buffer 618a, buffer 618b, and buffer 618c respectively. Image-processing module 616 may process image data 624 as it is received, conditional on having enough portions of image data 624 stored in buffer 618a. For example, as a portion of image data 624 is received, if there are enough portions of image data 624 in buffer 618a, image-processing module 616 may process image data 624 and output processed image data 630. Likewise, image-processing module 616 may process image data 626 as it is received, conditional on having enough portions, and image data 628 as it is received, conditional on having enough portions.

Each of the image-processing modules of system 600 may operate on image data as the image data is received. Thus, if image data 624, image data 626, and image data 628 are interleaved (e.g., as described with regard to FIG. 7), system 600 may process image data 624, image data 626, and image data 628 in an interleaved manner.

One issue that may affect operation of system 600 is that when a last portion of image data of a set of image data is received by an image-processing module (e.g., image-processing module 608 and/or image-processing module 616), the default behavior of the image-processing module may be to flush the set of image data. In the present disclosure, the term “flush” and like terms may refer to processing and/or outputting data based on all data remaining in a buffer. For example, image-processing module 608 may store 4 portions of image data 624 in buffer 610a (e.g., in cases in which each portion includes one line of image data), for example, based on using 5 lines of data to generate a processed portion of data, for example, based on including a 5×5 filter. When receiving the first four portions of image data 624, image-processing module 608 may buffer the first four portions in buffer 610a and not process or output anything. Upon receiving the fifth portion of image data 624, image-processing module 608 may process the first five portions to output a first processed portion of image data 624. Alternatively, any or all of the image-processing modules, (e.g., image-processing module 608) may implement a padding algorithm which allows the image-processing module to pad the missing image data on frame boundaries. Padding data on boundaries may artificially create lines of data, for example, when fewer than the number of lines used in processing have been received (e.g., at the beginning of a frame). Such a padding algorithm may implement zero padding or duplicate neighboring lines, etc. As such the image-processing modules may process image data when the image-processing modules have fewer than 5 lines of image data

In either case, the flushing may be an issue when a last portion (or frame) of image data is received. In response to receiving a last portion of image data 624, the default behavior of image-processing module 608 may be to immediately process all data of the portions of image data 624 in buffer 610a to output the remainder of processed image data 624. However, immediately processing all portions of image data 624 stored in buffer 610a may conflict with processing image data 626 and/or image data 628 as image data 626 and/or image data 628 are received. For example, using image data 702, image data 704, and image data 706 as an example, if image-data portion 702e were a last portion of image data 702, image-processing module 608 may, upon receiving image-data portion 702e, by default, immediately process image-data portion 702a, image-data portion 702b, image-data portion 702c, image-data portion 702d, and image-data portion 702e and output five portions of processed image data 702. However, processing image-data portion 702a, image-data portion 702b, image-data portion 702c, image-data portion 702d, and image-data portion 702e and outputting processed image data 702 may take time. During that time, image-processing module 608 may receive image-data portion 704c and/or image-data portion 706c. This may be a conflict because image-processing module 608 may be incapable of processing image data 702 and image-data portion 704c and/or image-data portion 706e at the same time.

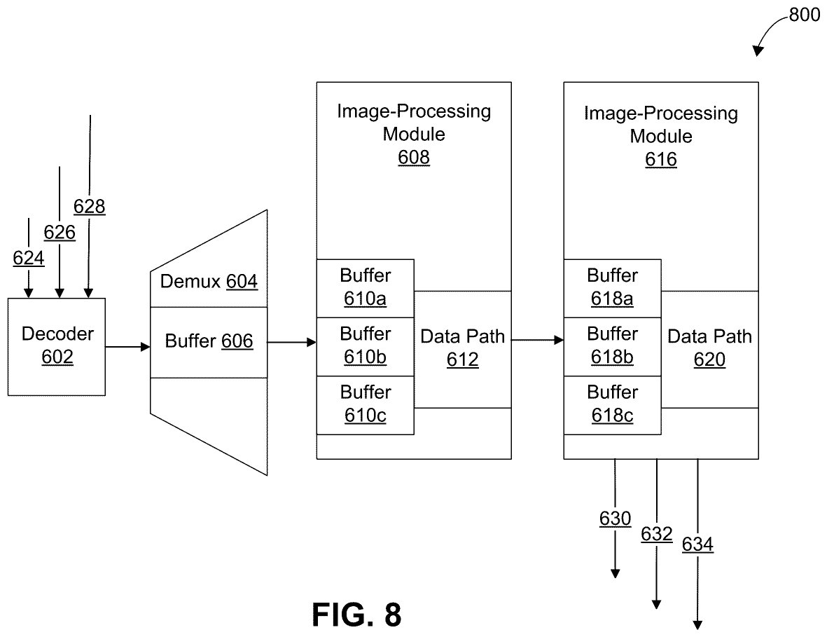

FIG. 8 is a block diagram illustrating an example system 800, which may be an image processor, according to various aspects of the present disclosure. System 800 may be an example of image processor 124 of FIG. 1, ISP 128 of FIG. 1, image processor 204 of FIG. 2, and/or image processor 404 of FIG. 4.

System 800 may include decoder 602, demultiplexer 604, and one or more image-processing modules (e.g., image-processing module 608 and image-processing module 616), all of which may be the same as, may be substantially similar to, and/or may perform the same, or substantially the same, operations as was described with regard to system 600 of FIG. 6. System 800 may process one or more sets of image data (e.g., image data 624, image data 626, and image data 628) to generate respective processed image data (e.g., processed image data 630, processed image data 632, and processed image data 634).

In addition to the elements included in system 600, system 800 may include buffer 606. Buffer 606 may be included in system 800 before a first image-processing module (e.g., image-processing module 608). For example, in some cases, buffer 606 may be included in demultiplexer 604. Additionally, or alternatively, system 600 may include a buffer separate from demultiplexer 604. Demultiplexer 604 is optional in system 800. For example, in some cases, system 800 may not include demultiplexer 604. In such cases, decoder 602 may provide image data (e.g., decoded image data) to buffer 606 which may be an independent module, or which may be included in another module.

Buffer 606 may buffer image data from one or more sets of image data while image-processing modules of system 800 flush data from a set of image data. In the present disclosure, the term “buffer,” when used as a verb, may refer to storing data for a period of time and providing the data after the period of time. Buffered data may be provided in the order it was received.

For example, in response to receiving a last portion of image data 624, buffer 606 may store all incoming portions of image data 626 and image data 628, at least until image-processing module 608 has flushed image data 624 from buffer 610a. After image-processing module 608 has flushed image data 624, image-processing module 608 may provide an indication that image-processing module 608 has processed image data 624 and/or that image-processing module 608 is ready to receive buffered data. In response to the indication, buffer 606 may deliver all portions of image data 626 and image data 628, in order, one at a time, as they were received. Buffer 606 may be sized to store a number of portions of image data based on how long it takes image-processing modules of system 800 to flush portions of image data. For example, if it takes as long to process 5 portions of image data as it takes to flush buffer 610a, buffer 606 may be sized to store at least 5 portions of image data. Additionally, or alternatively, buffer 606 may be sized based on an expected number of data sets that system 600 may be expected to receive. For example, buffer 606 may be sized to store 5 portions of image data for every set of image data that system 600 is expected to process (e.g., in case system 600 receives a last line of all of the sets of image data at about the same time).

Buffering image data 626 and/or image data 628 while image-processing module 608 flushes image data 624 may prevent image data 626 and/or image data 628 from conflicting with the flushing of image data 624. Thus, buffer 606 may address the issue of conflicts based on flushing.

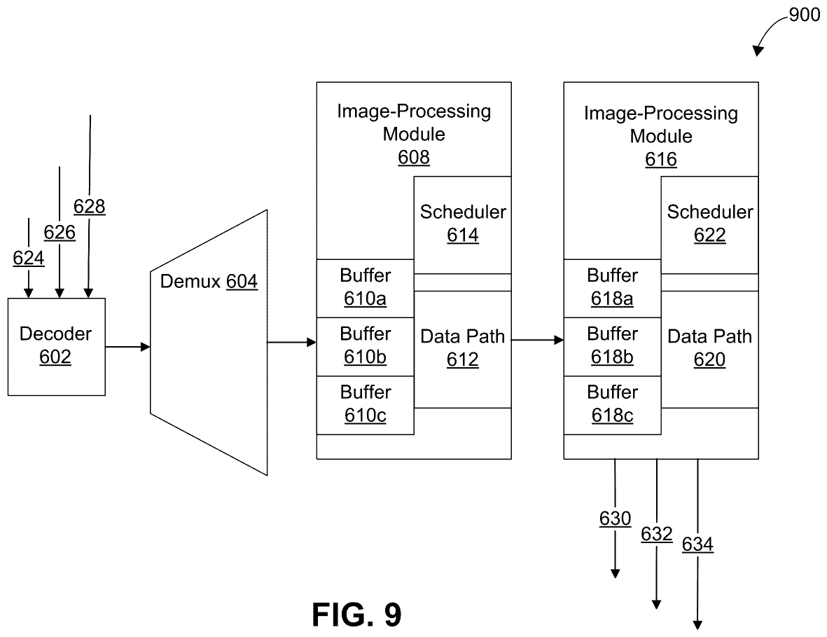

FIG. 9 is a block diagram illustrating an example system 900, which may be an image processor, according to various aspects of the present disclosure. System 900 may be an example of image processor 124 of FIG. 1, ISP 128 of FIG. 1, image processor 204 of FIG. 2, and/or image processor 404 of FIG. 4.

System 900 may include decoder 602, demultiplexer 604, and one or more image-processing modules (e.g., image-processing module 608 and image-processing module 616), all of which may be the same as, may be substantially similar to, and/or may perform the same, or substantially the same, operations as was described with regard to system 600 of FIG. 6. System 900 may process one or more sets of image data (e.g., image data 624, image data 626, and image data 628) to generate respective processed image data (e.g., processed image data 630, processed image data 632, and processed image data 634). Demultiplexer 604 is optional in system 900. For example, in some cases, system 900 may not include demultiplexer 604. In such cases, decoder 602 may provide image data (e.g., decoded image data) to image-processing module 608.

In addition to the elements included in system 600, one or more image-processing modules of system 900 may include a scheduler (e.g., image-processing module 608 may include scheduler 614 and image-processing module 616 may include scheduler 622). The scheduler of an image-processing module may schedule (e.g., to control a timing of) flushing operations such that the flushing operations do not conflict with processing of other data being received. As an example, image-processing module 608 may receive image data 624, image data 626, and image data 628 at respective regular intervals. Scheduler 614 of image-processing module 608 may recognize a respective timing of receiving image data 624, image data 626, and/or image data 628. Upon receiving a last portion of image data 624, scheduler 614 may schedule the flushing of buffer 610a such that the flushing of buffer 610a does not conflict with the receipt and processing of image data 626 and image data 628 based on the determined timing of receiving image data 626 and image data 628. In some cases, scheduler 614 may cause the flushing of buffer 610a to be according to the timing of receiving image data 624. For example, image-processing module 608 may receive image data 624, image data 626, and image data 628 in an interleaved manner. Scheduler 614 may recognize the interleaved manner. Scheduler 614 may cause the flushing of each of image data 624, image data 626, and image data 628, (when the respective last portions thereof are received) to follow the interleaved manner. For example, scheduler 614 may cause image-processing module 608 to flush a portion of buffer 610a (e.g., a portion of the same size as image data 624) at a time that a portion of image data 624 would be received according to the determined timing. As an example, if image-data portion 702a of image data 702 of FIG. 7 were a last portion of image data 702, scheduler 614 may schedule flushing of buffer 610a to correspond with the timing of image-data portion 702b, image-data portion 702c, image-data portion 702d, and image-data portion 702e. Scheduling flushing of buffer 610a during times corresponding to the receipt of image-data portion 702b, image-data portion 702c, image-data portion 702d, and image-data portion 702e prevents the flushing from conflicting with the receipt and processing of image-data portion 704b, image-data portion 706b, image-data portion 704c, image-data portion 706c, image-data portion 704d, image-data portion 706d, image-data portion 704c, and image-data portion 706c.

Scheduler 614 may modify a default behavior of image-processing module 608 by, rather that causing image-processing module 608 to immediately flush buffer 610a upon receiving a last portion of image data 624, causing image-processing module 608 to flush buffer 610a in such a way that the flushing of buffer 610a does not conflict with the processing of incoming image data 626 and/or incoming image data 628. In some cases, scheduler 614 may throttle flushing of buffers 610. For example, rather than allowing image-processing module 608 to flush all portions of image data 624 stored in buffer 610a immediately, scheduler 614 may cause image-processing module 608 to flush one portion of image data 624 stored in buffer 610a at a time (e.g., according to the determined timing of receiving image data 624).

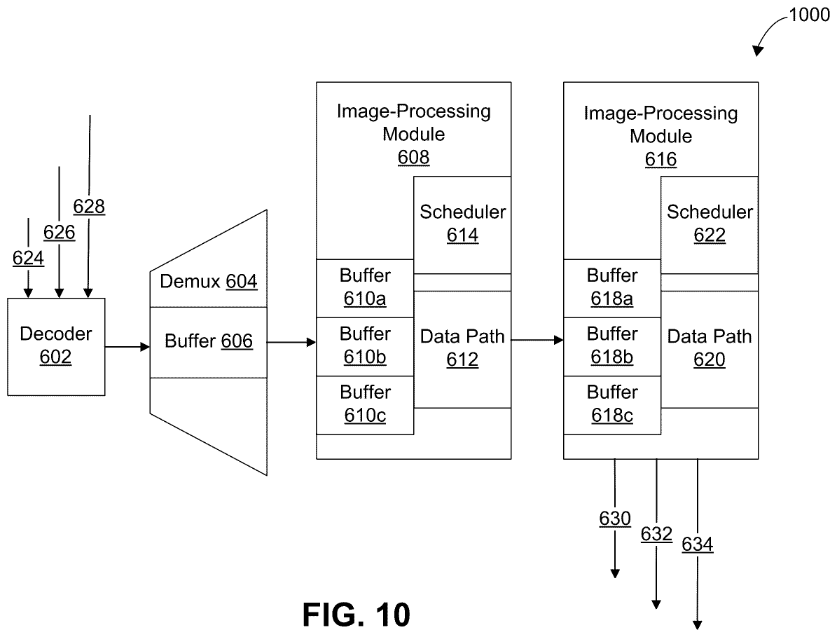

In some aspects, the throttling amount may be programmable. For example, scheduler 614 may be programmed to throttle the data-flush rate to be less than or more than one portion during a given time slot. For instance, scheduler 614 may be programmed to flush one to M portions of image data every N time slots (where time slot refers to the timing of receiving data portions of an image, e.g., the timing of receiving image-data portion 702b even when image-data portion 702a is a last portion of image data 702). For example, if image-data portion 702a is a last portion of image data 702 and N is 2 then during the time slot of image-data portion 702b, image-processing module 608 won't flush buffer 610a. Rather, image-processing module 608 will wait until the time slot of image-data portion 702c then flush one to M portions from buffer 610a. Further, during the time slot of image-data portion 702d image-processing module 608 won't flush buffer 610a. Rather, image-processing module 608 will wait until the time slot of image-data portion 702e to flush another one to M portions from buffer 610a. In some cases, (e.g., in the case of system 1000 of FIG. 10), N can be set as decimal value, such as 1.5 or 2.5. The possible values for N may be based on system requirements. If N is set to be less than 1, such as 0.5, scheduler 614 may try to cause image-processing module 608 to flush data every half time slot.

Further, in some aspects, scheduler 614 may determine when there is only one image data being received (e.g., image data 624 is being received but image data 626 and image data 628 are not being received). In such cases scheduler 614 may disable the throttling so that image-processing module 608 may flush all data in buffer 610a as fast as possible e.g., to improve performance.

FIG. 10 is a block diagram illustrating an example system 1000, which may be an image processor, according to various aspects of the present disclosure. System 1000 may be an example of image processor 124 of FIG. 1, ISP 128 of FIG. 1, image processor 204 of FIG. 2, and/or image processor 404 of FIG. 4.

System 1000 may include decoder 602, demultiplexer 604, and one or more image-processing modules (e.g., image-processing module 608 and image-processing module 616), all of which may be the same as, may be substantially similar to, and/or may perform the same, or substantially the same, operations as was described with regard to system 600 of FIG. 6. System 1000 may process one or more sets of image data (e.g., image data 624, image data 626, and image data 628) to generate respective processed image data (e.g., processed image data 630, processed image data 632, and processed image data 634).

In addition to the elements included in system 600, system 1000 may include buffer 606, which may be the same as, may be substantially similar to, and/or may perform the same, or substantially the same, operations as buffer 606 as described with regard to FIG. 8. Additionally, one or more image-processing modules of system 1000 may include a scheduler (e.g., image-processing module 608 may include scheduler 614 and image-processing module 616 may include scheduler 622). Each scheduler may be the same as, may be substantially similar to, and/or may perform the same, or substantially the same, operations as the schedulers described with regard to system 900 of FIG. 9. Demultiplexer 604 is optional in system 1000. For example, in some cases, system 1000 may not include demultiplexer 604. In such cases, decoder 602 may provide image data (e.g., decoded image data) to buffer 606 which may be an independent module, or which may be included in another module.

Comparing system 800, system 900 and system 1000, the buffer 606 of system 800 may need to be large, e.g., large enough to buffer several portions of image data. The schedulers of system 900 may prevent conflicts as long as the incoming image-data portions are received at regular and predictable intervals. The schedulers of the image-processing modules of system 1000 may prevent many conflicts (e.g., when the image data is received in a regular and predictable manner). The buffer 606 of system 1000 may prevent conflicts when image data is received in an irregular manner (e.g., by buffering image data while flushing occurs). The buffer 606 of system 1000 may be smaller than the buffer 606 of system 800 because the schedulers of the image-processing modules may prevent many conflicts and the buffer 606 of system 1000 may be sized to handle fewer portions of image data than the buffer 606 of system 800.

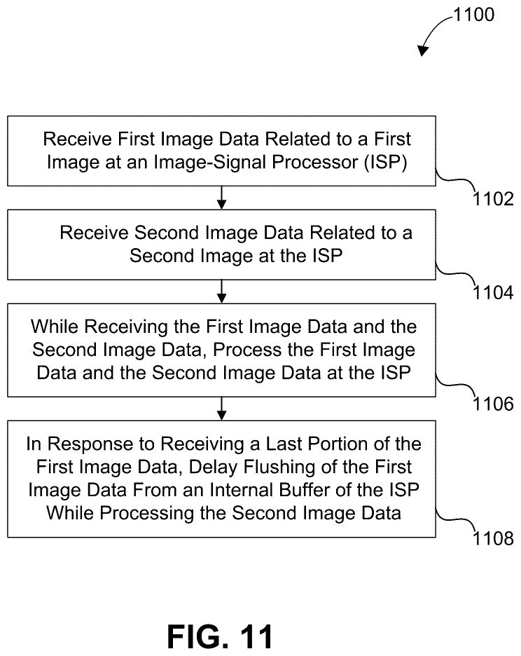

FIG. 11 is a flow diagram illustrating an example process 1100 for processing image data, in accordance with aspects of the present disclosure. One or more operations of process 1100 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The one or more operations of process 1100 may be implemented as software components that are executed and run on one or more processors.

At block 1102, a computing device (or one or more components thereof) may receive first image data related to a first image at an image-signal processor (ISP). For example, image-processing module 608 of FIG. 6 may receive a portion of image data 624 of FIG. 6.

At block 1104, the computing device (or one or more components thereof) may receive second image data related to a second image at the ISP. For example, image-processing module 608 may receive a portion of image data 626 of FIG. 6.

In some aspects, the first image data and the second image data are received in a time-interleaved manner. For example, image data 702, image data 704, and image data 706 may be received by image-processing module 608 in a time-interleaved manner (e.g., with portions of image data 704 and portions of image data 706 received between portions of image data 702).

At block 1106, the computing device (or one or more components thereof) may while receiving the first image data and the second image data, process the first image data and the second image data at the ISP. For example, image-processing module 608 may process image data 624 and image data 626. In some aspects, image-processing module 608 may process image data 624 and image data 626 in a time-interleaved manner.

At block 1108, the computing device (or one or more components thereof) may, in response to receiving a last portion of the first image data, delay flushing of the first image data from an internal buffer of the ISP while processing the second image data. For example, image-processing module 608 may receive a last portion of image data 624. Image-processing module 608 (e.g., based on instructions from scheduler 614 of FIG. 9 or of FIG. 10) may delay flushing of image data 624 from buffer 610a during times in which image data 626 is being processed by image-processing module 608.

In some aspects, to delay flushing of the first image data from the internal buffer the computing device (or one or more components thereof) may flush the first image data from the internal buffer in a time-interleaved manner. For example, if image-data portion 702a of FIG. 7 is a last portion of image data 702, and other portions of 702 illustrated in FIG. 7 represent time slots, image-processing module 608 may process image data 702 when image-data portion 702a is received, may process image data 704 when image-data portion 704a is received, may flush at least a portion of image data 702 from a buffer (e.g., buffer 610a) at a time slot represented by 702b, may process image data 704 when image-data portion 704b is received, may flush at least a portion of image data 702 from a buffer at a time slot represented by 702c, etc.

In some aspects, to delay flushing of the first image data from the internal buffer the computing device (or one or more components thereof) may predict periods for processing of the second image data; and flush the first image data from the internal buffer between the periods for processing of the second image data. For example, scheduler 614 may determine a delay between image-data portion 704a and image-data portion 704b and/or a delay between image-data portion 704b and image-data portion 704c. Based on one or both of the delays, scheduler 614 may predict time slots for image-data portion 704d and image-data portion 704c. If image-data portion 702c of FIG. 7 is a last portion of image data 702, scheduler 614 may determine to not flush image data 702 at the predicted times slots for image-data portion 704d and image-data portion 704c.

In some aspects, wherein to delay flushing of the first image data from the internal buffer the computing device (or one or more components thereof) may observe time slots during which the second image data is received and processed; predict time slots for processing of the second image data based on the observed time slots; and flush the first image data from the internal buffer between the predicted time slots for processing of the second image data. For example, scheduler 614 may determine a delay between image-data portion 704a and image-data portion 704b and/or a delay between image-data portion 704b and image-data portion 704c. Based on one or both of the delays, scheduler 614 may predict time slots for image-data portion 704d and image-data portion 704c. If image-data portion 702c of FIG. 7 is a last portion of image data 702, scheduler 614 may determine to flush image data 702 between the predicted times slots for image-data portion 704d and image-data portion 704c.

In some aspects, to delay flushing of the first image data from the computing device (or one or more components thereof) may observe time slots during which the first image data is received and processed; determine time slots for processing of the first image data based on the observed time slots; and in response to receiving a last portion of the first image data, flush the first image data from the internal buffer during the time slots for processing of the first image data. For example, scheduler 614 may determine a delay between image-data portion 702a and image-data portion 702b and/or a delay between image-data portion 702b and image-data portion 702c. Based on one or both of the delays, scheduler 614 may predict time slots for image-data portion 702d and image-data portion 702e. If image-data portion 702c of FIG. 7 is a last portion of image data 702, scheduler 614 may determine to flush image data 702 at the predicted times slots for image-data portion 702d and image-data portion 702e.

In some aspects, to delay flushing of the first image data from the internal buffer the computing device (or one or more components thereof) may observe or determine an incoming data rate at which the second image data is received; and flush the first image data from the internal buffer at a flushing data rate that is based on the incoming data rate. For example, scheduler 614 may determine a delay between image-data portion 704a and image-data portion 704b and/or a delay between image-data portion 704b and image-data portion 704c. Based on one or both of the delays, scheduler 614 may determine an incoming data rate for 704. If image-data portion 702c of FIG. 7 is a last portion of image data 702, scheduler 614 may determine to flush image data 702 based on the determined incoming data rate for image data 704.

In some aspects, to delay flushing of the first image data from the internal buffer the computing device (or one or more components thereof) may observe or determine an incoming data rate at which the first image data is received; and flush the first image data from the internal buffer at a flushing data rate that is based on the incoming data rate. For example, scheduler 614 may determine a delay between image-data portion 702a and image-data portion 702b and/or a delay between image-data portion 702b and image-data portion 702c. Based on one or both of the delays, scheduler 614 may determine an incoming data rate for 702. If image-data portion 702c of FIG. 7 is a last portion of image data 702, scheduler 614 may determine to flush image data 702 based on the determined incoming data rate for image data 702.

In some aspects, to receive the first image data the computing device (or one or more components thereof) may receive the first image data one portion at a time. To receive the second image data the computing device (or one or more components thereof) may receive the second image data one portion at a time. Portions of the second image data are received between portions of the first image data. To process the first image data and the second image data the computing device (or one or more components thereof) may, in response to receiving a portion of the first image data: store the portion of the first image data with one or more previously-received portions of the first image data in a first internal buffer; process the portion of the first image data and the one or more previously-received portions of the first image data; and output a processed portion of the first image data. To process the first image data and the second image data the computing device (or one or more components thereof) may, in response to receiving a portion of the second image data: store the portion of the second image data with one or more previously-received portions of the second image data in a second internal buffer; process the portion of the second image data and the one or more previously-received portions of the second image data; and output a processed portion of the second image data. To delay flushing of the first image data from the internal buffer of the ISP while processing the second image data the computing device (or one or more components thereof) may in response to receiving the last portion of the first image data: process the last portion of the first image data and the one or more previously-received portions of the first image data; output a respective processed portion of the first image data for each of the last portion of the first image data and the one or more previously-received portions of the first image data; and delay between outputting each of the respective processed portions of the first image data by a duration related to processing a portion of data.

For example, image-processing module 608 may receive image data 702 one portion at a time. Further, image-processing module 608 may receive image data 704 one portion at a time. Portions of image data 704 may be received between portions of image data 702. For example, image-data portion 704d may be received between image-data portion 702d and image-data portion 702e. To process image data 702 and image data 704, in response to receiving image-data portion 702d, image-processing module 608 may store image-data portion 702d in buffer 610a with one or more previously-received portions of image data 702 (e.g., image-data portion 702c, image-data portion 702b, and image-data portion 702a), process image-data portion 702d with the one or more previously-received portions of image data 702, and output a processed portion of image data 702. Further, to process image data 702 and image data 704, in response to receiving image-data portion 704d, image-processing module 608 may store image-data portion 704d in buffer 610b with one or more previously-received portions of image data 704 (e.g., image-data portion 704c, image-data portion 704b, and image-data portion 704a), process image-data portion 704d with the one or more previously-received portions of image data 704, and output a processed portion of image data 704. Further, image-processing module 608 may delay flushing of image data 702 from buffer 610a while processing image data 704. For example, in response to receiving image-data portion 702e of image data 702, image-processing module 608 may process image-data portion 702e with the one or more previously-received portions of image data 702 (e.g., image-data portion 702d, image-data portion 702c, image-data portion 702b, and image-data portion 702a), and output a processed portion of image data 702. Further, image-processing module 608 may output a respective processed portion of image data 702 for each of image-data portion 702a, image-data portion 702b, image-data portion 702c, image-data portion 702d, and image-data portion 702e. However, image-processing module 608 may delay between outputting each of the respective processed portions of image data 702 by a duration related to processing a portion of image data 704.

In some aspects, the computing device (or one or more components thereof) may buffer the second image data while flushing of the first image data from the internal buffer of the ISP. For example, system 800 (or system 1000) may buffer image data 704 at buffer 606 while image-processing module 608 flushes image data 702 from buffer 610a. In some aspects, to buffer the second image data, the computing device (or one or more components thereof) may store received second image data while the first image data is flushed from the internal buffer of the ISP and process the received second image data after the first image data is flushed from the internal buffer of the ISP. For example, if image-data portion 702a is a last portion of image data 702, system 800 (or system 1000) may buffer image-data portion 704a, image-data portion 704b, image-data portion 704c, image-data portion 704d, and image-data portion 704e at buffer 606 while image-processing module 608 flushes image data 702 from buffer 610a. After image-processing module 608 flushes image data 702 from buffer 610a, buffer 606 may provide image-data portion 704a, image-data portion 704b, image-data portion 704c, image-data portion 704d, and image-data portion 704e to image-processing module 608 for processing. Upon receiving image-data portion 704a, image-data portion 704b, image-data portion 704c, image-data portion 704d, and image-data portion 704c, image-processing module 608 may process image data 704.

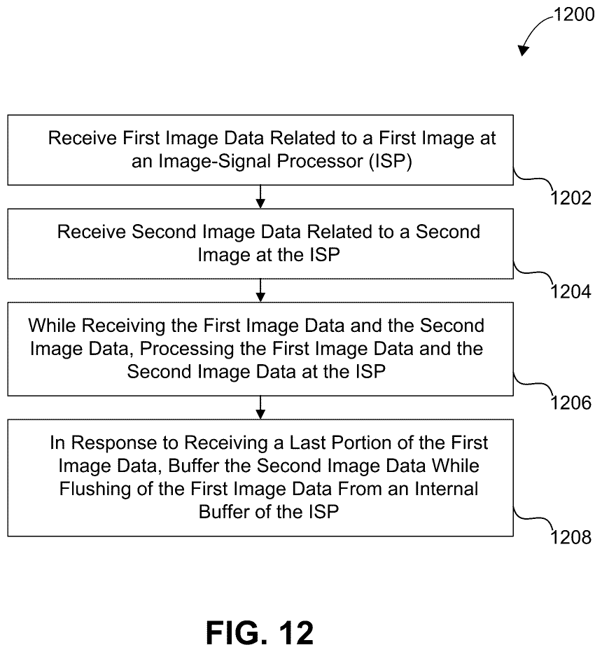

FIG. 12 is a flow diagram illustrating an example process 1200 for processing image data, in accordance with aspects of the present disclosure. One or more operations of process 1200 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device,, and/or any other computing device with the resource capabilities to perform the process 1200. The one or more operations of process 1200 may be implemented as software components that are executed and run on one or more processors.

At block 1202, a computing device (or one or more components thereof) may receive first image data related to a first image at an image-signal processor (ISP). For example, image-processing module 608 of FIG. 6 may receive a portion of image data 624 of FIG. 6.

At block 1204, the computing device (or one or more components thereof) may receive second image data related to a second image at the ISP. For example, image-processing module 608 may receive a portion of image data 626 of FIG. 6.

In some aspects, the first image data and the second image data are received in a time-interleaved manner. For example, image data 702, image data 704, and image data 706 may be received by image-processing module 608 in a time-interleaved manner (e.g., with portions of image data 704 and portions of image data 706 received between portions of image data 702).

At block 1206, the computing device (or one or more components thereof) may, while receiving the first image data and the second image data, process the first image data and the second image data at the ISP. For example, image-processing module 608 may process image data 624 and image data 626. In some aspects, image-processing module 608 may process image data 624 and image data 626 in a time-interleaved manner.

At block 1208, the computing device (or one or more components thereof) may, in response to receiving a last portion of the first image data, buffer the second image data while flushing the first image data from an internal buffer of the ISP. For example, system 800 (or system 1000) may buffer image data 704 at buffer 606 while image-processing module 608 flushes image data 702 from buffer 610a.

In some aspects, to buffer the second image data, the computing device (or one or more components thereof) may store received second image data while the first image data is flushed from the internal buffer of the ISP and process the received second image data after the first image data is flushed from the internal buffer of the ISP. For example, if image-data portion 702a is a last portion of image data 702, system 800 (or system 1000) may buffer image-data portion 704a, image-data portion 704b, image-data portion 704c, image-data portion 704d, and image-data portion 704c at buffer 606 while image-processing module 608 flushes image data 702 from buffer 610a. After image-processing module 608 flushes image data 702 from buffer 610a, buffer 606 may provide image-data portion 704a, image-data portion 704b, image-data portion 704c, image-data portion 704d, and image-data portion 704e to image-processing module 608 for processing. Upon receiving image-data portion 704a, image-data portion 704b, image-data portion 704c, image-data portion 704d, and image-data portion 704e, image-processing module 608 may process image data 704.

In some aspects, the computing device (or one or more components thereof) may, in response to receiving a last portion of the first image data, flush the first image data from the internal buffer of the ISP; while flushing the first image data, receive second image data at a buffer; store the second image data received while flushing the first image data at the buffer; after flushing the first image data, provide the second image data received while flushing the first image data from the buffer to the ISP; and process the second image data received while flushing the first image data. For example, if image-data portion 702a is a last portion of image data 702, system 800 (or system 1000) may buffer image-data portion 704a, image-data portion 704b, image-data portion 704c, image-data portion 704d, and image-data portion 704e at buffer 606 while image-processing module 608 flushes image data 702 from buffer 610a. After image-processing module 608 flushes image data 702 from buffer 610a, buffer 606 may provide image-data portion 704a, image-data portion 704b, image-data portion 704c, image-data portion 704d, and image-data portion 704e to image-processing module 608 for processing. Upon receiving image-data portion 704a, image-data portion 704b, image-data portion 704c, image-data portion 704d, and image-data portion 704c, image-processing module 608 may process image data 704.

In some aspects, the computing device (or one or more components thereof) may delay flushing of the first image data from in an internal buffer of the ISP while processing the second image data. For example, image-processing module 608 may receive a last portion of image data 624. Image-processing module 608 (e.g., based on instructions from scheduler 614 of FIG. 9 or of FIG. 10) may delay flushing of image data 624 from buffer 610a during times in which image data 626 is being processed by image-processing module 608.

In some aspects, to delay flushing of the first image data from the internal buffer the computing device (or one or more components thereof) may predict periods for processing of the second image data; and flush the first image data from the internal buffer between the periods for processing of the second image data. For example, scheduler 614 may determine a delay between image-data portion 704a and image-data portion 704b and/or a delay between image-data portion 704b and image-data portion 704c. Based on one or both of the delays, scheduler 614 may predict time slots for image-data portion 704d and image-data portion 704e. If image-data portion 702c of FIG. 7 is a last portion of image data 702, scheduler 614 may determine to not flush image data 702 at the predicted times slots for image-data portion 704d and image-data portion 704c.

In some examples, as noted previously, the methods described herein (e.g., process 1100 of FIG. 11, process 1200 of FIG. 12, and/or other methods described herein) can be performed, in whole or in part, by a computing device or apparatus. In another example, one or more of the methods (e.g., process 1100 of FIG. 11, process 1200 of FIG. 12, and/or other methods described herein) can be performed, in whole or in part, by the computing-device architecture 1300 shown in FIG. 13. For instance, a computing device with the computing-device architecture 1300 shown in FIG. 13 can include, or be included in, the components of the computing device and can implement the operations of process 1100, process 1200, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 1100, process 1200, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 1100, process 1200, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

FIG. 13 illustrates an example computing-device architecture 1300 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device.

The components of computing-device architecture 1300 are shown in electrical communication with each other using connection 1312, such as a bus. The example computing-device architecture 1300 includes a processing unit (CPU or processor) 1302 and computing device connection 1312 that couples various computing device components including computing device memory 1310, such as read only memory (ROM) 1308 and random-access memory (RAM) 1306, to processor 1302.

Computing-device architecture 1300 can include a cache of high-speed memory connected directly with, in close proximity to, or integrated as part of processor 1302. Computing-device architecture 1300 can copy data from memory 1310 and/or the storage device 1314 to cache 1304 for quick access by processor 1302. In this way, the cache can provide a performance boost that avoids processor 1302 delays while waiting for data. These and other modules can control or be configured to control processor 1302 to perform various actions. Other computing device memory 1310 may be available for use as well. Memory 1310 can include multiple different types of memory with different performance characteristics. Processor 1302 can include any general-purpose processor and a hardware or software service, such as service 1 1316, service 2 1318, and service 3 1320 stored in storage device 1314, configured to control processor 1302 as well as a special-purpose processor where software instructions are incorporated into the processor design. Processor 1302 may be a self-contained system, containing multiple cores or processors, a bus, memory controller, cache, etc. A multi-core processor may be symmetric or asymmetric.

To enable user interaction with the computing-device architecture 1300, input device 1322 can represent any number of input mechanisms, such as a microphone for speech, a touch-sensitive screen for gesture or graphical input, keyboard, mouse, motion input, speech and so forth. Output device 1324 can also be one or more of a number of output mechanisms known to those of skill in the art, such as a display, projector, television, speaker device, etc. In some instances, multimodal computing devices can enable a user to provide multiple types of input to communicate with computing-device architecture 1300. Communication interface 1326 can generally govern and manage the user input and computing device output. There is no restriction on operating on any particular hardware arrangement and therefore the basic features here may easily be substituted for improved hardware or firmware arrangements as they are developed.

Storage device 1314 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 1306, read only memory (ROM) 1308, and hybrids thereof. Storage device 1314 can include services 1316, 1318, and 1320 for controlling processor 1302. Other hardware or software modules are contemplated. Storage device 1314 can be connected to the computing device connection 1312. In one aspect, a hardware module that performs a particular function can include the software component stored in a computer-readable medium in connection with the necessary hardware components, such as processor 1302, connection 1312, output device 1324, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information. data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“s”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for processing image data, the apparatus comprising: at least one memory; and at least one processor coupled to the at least one memory and configured to: receive first image data related to a first image at an image-signal processor (ISP); receive second image data related to a second image at the ISP; while receiving the first image data and the second image data, process the first image data and the second image data at the ISP; and in response to receiving a last portion of the first image data, delay flushing of the first image data from an internal buffer of the ISP while processing the second image data.

Aspect 2. The apparatus of aspect 1, wherein to delay flushing of the first image data from the internal buffer the at least one processor is further configured to flush the first image data from the internal buffer in a time-interleaved manner.

Aspect 3. The apparatus of any one of aspects 1 or 2, wherein to delay flushing of the first image data from the internal buffer the at least one processor is further configured to: predict periods for processing of the second image data; and flush the first image data from the internal buffer between the periods for processing of the second image data.

Aspect 4. The apparatus of any one of aspects 1 to 3, wherein to delay flushing of the first image data from the internal buffer the at least one processor is further configured to: observe time slots during which the second image data is received and processed; predict time slots for processing of the second image data based on the observed time slots; and flush the first image data from the internal buffer between the predicted time slots for processing of the second image data.

Aspect 5. The apparatus of any one of aspects 1 to 4, wherein to delay flushing of the first image data from the internal buffer the at least one processor is further configured to: observe time slots during which the first image data is received and processed; determine time slots for processing of the first image data based on the observed time slots; and in response to receiving a last portion of the first image data, flush the first image data from the internal buffer during the time slots for processing of the first image data.

Aspect 6. The apparatus of any one of aspects 1 to 5, wherein to delay flushing of the first image data from the internal buffer the at least one processor is further configured to: observe an incoming data rate at which the second image data is received; and flush the first image data from the internal buffer at a flushing data rate that is based on the incoming data rate.

Aspect 7. The apparatus of any one of aspects 1 to 6, wherein: to receive the first image data the at least one processor is further configured to receive the first image data one portion at a time; to receive the second image data the at least one processor is further configured to receive the second image data one portion at a time; portions of the second image data are received between portions of the first image data; to process the first image data and the second image data the at least one processor is further configured to: in response to receiving a portion of the first image data: store the portion of the first image data with one or more previously-received portions of the first image data in a first internal buffer; process the portion of the first image data and the one or more previously-received portions of the first image data; and output a processed portion of the first image data; and in response to receiving a portion of the second image data: store the portion of the second image data with one or more previously-received portions of the second image data in a second internal buffer; process the portion of the second image data and the one or more previously-received portions of the second image data; and output a processed portion of the second image data; and to delay flushing of the first image data from the internal buffer of the ISP while processing the second image data the at least one processor is further configured to: in response to receiving the last portion of the first image data: process the last portion of the first image data and the one or more previously-received portions of the first image data; output a respective processed portion of the first image data for each of the last portion of the first image data and the one or more previously-received portions of the first image data; and delay between outputting each of the respective processed portions of the first image data by a duration related to processing a portion of data.

Aspect 8. The apparatus of any one of aspects 1 to 7, wherein the first image data and the second image data are received in a time-interleaved manner.

Aspect 9. The apparatus of any one of aspects 1 to 8, wherein the at least one processor is further configured to: buffer the second image data while flushing of the first image data from the internal buffer of the ISP.

Aspect 10. The apparatus of aspect 9, wherein to buffer the second image data the at least one processor is further configured to store received second image data while the first image data is flushed from the internal buffer of the ISP and process the received second image data after the first image data is flushed from the internal buffer of the ISP.

Aspect 11. An apparatus for processing image data, the apparatus comprising: at least one memory; and at least one processor coupled to the at least one memory and configured to: receive first image data related to a first image at an image-signal processor (ISP); receive second image data related to a second image at the ISP; while receiving the first image data and the second image data, process the first image data and the second image data at the ISP; and in response to receiving a last portion of the first image data, buffer the second image data while flushing the first image data from an internal buffer of the ISP.

Aspect 12. The apparatus of aspect 11, wherein to buffer the second image data the at least one processor is further configured to store received second image data while the first image data is flushed from the internal buffer of the ISP and process the received second image data after the first image data is flushed from the internal buffer of the ISP.

Aspect 13. The apparatus of any one of aspects 11 or 12, wherein the at least one processor is further configured to: in response to receiving a last portion of the first image data, flush the first image data from the internal buffer of the ISP; while flushing the first image data, receive second image data at a buffer; store the second image data received while flushing the first image data at the buffer; after flushing the first image data, provide the second image data received while flushing the first image data from the buffer to the ISP; and process the second image data received while flushing the first image data.

Aspect 14. The apparatus of any one of aspects 11 to 13, wherein the at least one processor is further configured to delay flushing of the first image data from in an internal buffer of the ISP while processing the second image data.

Aspect 15. The apparatus of aspect 14, wherein to delay flushing of the first image data from the internal buffer the at least one processor is further configured to: predict periods for processing of the second image data; and flush the first image data from the internal buffer between the periods for processing of the second image data.

Aspect 16. The apparatus of aspects 11 to 15, wherein the first image data and the second image data are received in a time-interleaved manner.

Aspect 17. A method for processing image data, the method comprising: receiving first image data related to a first image at an image-signal processor (ISP); receiving second image data related to a second image at the ISP; while receiving the first image data and the second image data, processing the first image data and the second image data at the ISP; and in response to receiving a last portion of the first image data, delaying flushing of the first image data from an internal buffer of the ISP while processing the second image data.

Aspect 18. The method of aspect 17, wherein delaying flushing of the first image data from the internal buffer comprises flushing the first image data from the internal buffer in a time-interleaved manner.

Aspect 19. The method of aspects 17 or 18, wherein delaying flushing of the first image data from the internal buffer comprises: predicting periods for processing of the second image data; and flushing the first image data from the internal buffer between the periods for processing of the second image data.

Aspect 20. The method of aspects 17 to 19, wherein delaying flushing of the first image data from the internal buffer comprises: observing time slots during which the second image data is received and processed; predicting time slots for processing of the second image data based on the observed time slots; and flushing the first image data from the internal buffer between the predicted time slots for processing of the second image data.

Aspect 21. The method of aspects 17 to 20, wherein delaying flushing of the first image data from the internal buffer comprises: observing time slots during which the first image data is received and processed; determining time slots for processing of the first image data based on the observed time slots; and in response to receiving a last portion of the first image data, flushing the first image data from the internal buffer during the time slots for processing of the first image data.

Aspect 22. The method of aspects 17 to 21, wherein delaying flushing of the first image data from the internal buffer comprises: observing an incoming data rate at which the second image data is received; and flushing the first image data from the internal buffer at a flushing data rate that is based on the incoming data rate.

Aspect 23. The method of aspects 17 to 22, wherein: receiving the first image data comprises receiving the first image data one portion at a time; receiving the second image data comprises receiving the second image data one portion at a time; portions of the second image data are received between portions of the first image data; processing the first image data and the second image data comprises: in response to receiving a portion of the first image data: storing the portion of the first image data with one or more previously-received portions of the first image data in a first internal buffer; processing the portion of the first image data and the one or more previously-received portions of the first image data; and outputting a processed portion of the first image data; and in response to receiving a portion of the second image data: storing the portion of the second image data with one or more previously-received portions of the second image data in a second internal buffer; processing the portion of the second image data and the one or more previously-received portions of the second image data; and outputting a processed portion of the second image data; and delaying flushing of the first image data from the internal buffer of the ISP while processing the second image data comprises: in response to receiving the last portion of the first image data: processing the last portion of the first image data and the one or more previously-received portions of the first image data; outputting a respective processed portion of the first image data for each of the last portion of the first image data and the one or more previously-received portions of the first image data; and delaying between outputting each of the respective processed portions of the first image data by a duration related to processing a portion of data.

Aspect 24. The method of aspects 17 to 23, wherein the first image data and the second image data are received in a time-interleaved manner.

Aspect 25. The method of aspects 17 to 24, further comprising: buffering the second image data while flushing of the first image data from the internal buffer of the ISP.

Aspect 26. The method of aspect 25, wherein buffering the second image data comprises storing received second image data while the first image data is flushed from the internal buffer of the ISP and processing the received second image data after the first image data is flushed from the internal buffer of the ISP.

Aspect 27. A method for processing image data, the method comprising: receiving first image data related to a first image at an image-signal processor (ISP); receiving second image data related to a second image at the ISP; while receiving the first image data and the second image data, processing the first image data and the second image data at the ISP; and in response to receiving a last portion of the first image data, buffering the second image data while flushing the first image data from an internal buffer of the ISP.

Aspect 28. The method of aspect 27, wherein buffering the second image data comprises storing received second image data while the first image data is flushed from the internal buffer of the ISP and processing the received second image data after the first image data is flushed from the internal buffer of the ISP.

Aspect 29. The method of aspects 27 or 28, further comprising: in response to receiving a last portion of the first image data, flushing the first image data from the internal buffer of the ISP; while flushing the first image data, receiving second image data at a buffer; storing the second image data received while flushing the first image data at the buffer; after flushing the first image data, providing the second image data received while flushing the first image data from the buffer to the ISP; and processing the second image data received while flushing the first image data.

Aspect 30. The method of aspects 27 to 29, further comprising delaying flushing of the first image data from in an internal buffer of the ISP while processing the second image data.

Aspect 31. The method of aspect 30, wherein delaying flushing of the first image data from the internal buffer comprises: predicting periods for processing of the second image data; and flushing the first image data from the internal buffer between the periods for processing of the second image data.

Aspect 32. The method of aspects 27 to 31, wherein the first image data and the second image data are received in a time-interleaved manner.

Aspect 33. The method of any one of aspects 17 to 26, wherein delaying flushing of the first image data from the internal buffer comprises: observing an incoming data rate at which the first image data is received; and flushing the first image data from the internal buffer at a flushing data rate that is based on the incoming data rate.

Aspect 34. A non-transitory computer-readable storage medium having stored thereon instructions that, when executed by at least one processor, cause the at least one processor to perform operations according to any of aspects 17 to 33.

Aspect 35. An apparatus for providing virtual content for display, the apparatus comprising one or more means for perform operations according to any of aspects 17 to 33.

Aspect 36. The apparatus of any one of aspects 1 to 10, wherein, to delay flushing of the first image data from the internal buffer, the at least one processor is further configured to: observe an incoming data rate at which the first image data is received; and flush the first image data from the internal buffer at a flushing data rate that is based on the incoming data rate.

What is claimed is:

1. An apparatus for processing image data, the apparatus comprising:
at least one memory; and
at least one processor coupled to the at least one memory and configured to:
receive first image data related to a first image at an image-signal processor (ISP);
receive second image data related to a second image at the ISP;
while receiving the first image data and the second image data, process the first image data and the second image data at the ISP; and
in response to receiving a last portion of the first image data, delay flushing of the first image data from an internal buffer of the ISP while processing the second image data.

2. The apparatus of claim 1, wherein, to delay flushing of the first image data from the internal buffer, the at least one processor is further configured to flush the first image data from the internal buffer in a time-interleaved manner.

3. The apparatus of claim 1, wherein, to delay flushing of the first image data from the internal buffer, the at least one processor is further configured to:
predict periods for processing of the second image data; and
flush the first image data from the internal buffer between the periods for processing of the second image data.

4. The apparatus of claim 1, wherein, to delay flushing of the first image data from the internal buffer, the at least one processor is further configured to:
observe time slots during which the second image data is received and processed;
predict time slots for processing of the second image data based on the observed time slots; and
flush the first image data from the internal buffer between the predicted time slots for processing of the second image data.

5. The apparatus of claim 1, wherein, to delay flushing of the first image data from the internal buffer, the at least one processor is further configured to:
observe time slots during which the first image data is received and processed;
determine time slots for processing of the first image data based on the observed time slots; and
in response to receiving a last portion of the first image data, flush the first image data from the internal buffer during the time slots for processing of the first image data.

6. The apparatus of claim 1, wherein, to delay flushing of the first image data from the internal buffer, the at least one processor is further configured to:
observe an incoming data rate at which the second image data is received; and
flush the first image data from the internal buffer at a flushing data rate that is based on the incoming data rate.

7. The apparatus of claim 1, wherein, to delay flushing of the first image data from the internal buffer, the at least one processor is further configured to:
observe an incoming data rate at which the first image data is received; and
flush the first image data from the internal buffer at a flushing data rate that is based on the incoming data rate.

8. The apparatus of claim 1, wherein:
to receive the first image data the at least one processor is further configured to receive the first image data one portion at a time;
to receive the second image data the at least one processor is further configured to receive the second image data one portion at a time;
portions of the second image data are received between portions of the first image data;
to process the first image data and the second image data the at least one processor is further configured to:
in response to receiving a portion of the first image data:
store the portion of the first image data with one or more previously-received portions of the first image data in a first internal buffer;
process the portion of the first image data and the one or more previously-received portions of the first image data; and
output a processed portion of the first image data; and
in response to receiving a portion of the second image data:
store the portion of the second image data with one or more previously-received portions of the second image data in a second internal buffer;
process the portion of the second image data and the one or more previously-received portions of the second image data; and
output a processed portion of the second image data; and
to delay flushing of the first image data from the internal buffer of the ISP while processing the second image data the at least one processor is further configured to:
in response to receiving the last portion of the first image data:
process the last portion of the first image data and the one or more previously-received portions of the first image data;
output a respective processed portion of the first image data for each of the last portion of the first image data and the one or more previously-received portions of the first image data; and
delay between outputting each of the respective processed portions of the first image data by a duration related to processing a portion of data.

9. The apparatus of claim 1, wherein the first image data and the second image data are received in a time-interleaved manner.

10. The apparatus of claim 1, wherein the at least one processor is further configured to: buffer the second image data while flushing of the first image data from the internal buffer of the ISP.

11. The apparatus of claim 10, wherein, to buffer the second image data, the at least one processor is further configured to store received second image data while the first image data is flushed from the internal buffer of the ISP and process the received second image data after the first image data is flushed from the internal buffer of the ISP.

12. An apparatus for processing image data, the apparatus comprising:
at least one memory; and
at least one processor coupled to the at least one memory and configured to:
receive first image data related to a first image at an image-signal processor (ISP);
receive second image data related to a second image at the ISP;
while receiving the first image data and the second image data, process the first image data and the second image data at the ISP; and
in response to receiving a last portion of the first image data, buffer the second image data while flushing the first image data from an internal buffer of the ISP.

13. The apparatus of claim 12, wherein to buffer the second image data the at least one processor is further configured to store received second image data while the first image data is flushed from the internal buffer of the ISP and process the received second image data after the first image data is flushed from the internal buffer of the ISP.

14. The apparatus of claim 12, wherein the at least one processor is further configured to:
in response to receiving a last portion of the first image data, flush the first image data from the internal buffer of the ISP;
while flushing the first image data, receive second image data at a buffer;
store the second image data received while flushing the first image data at the buffer;
after flushing the first image data, provide the second image data received while flushing the first image data from the buffer to the ISP; and
process the second image data received while flushing the first image data.

15. The apparatus of claim 12, wherein the at least one processor is further configured to delay flushing of the first image data from in an internal buffer of the ISP while processing the second image data.

16. The apparatus of claim 15, wherein, to delay flushing of the first image data from the internal buffer, the at least one processor is further configured to:
predict periods for processing of the second image data; and
flush the first image data from the internal buffer between the periods for processing of the second image data.

17. The apparatus of claim 12, wherein the first image data and the second image data are received in a time-interleaved manner.

18. A method for processing image data, the method comprising:
receiving first image data related to a first image at an image-signal processor (ISP);
receiving second image data related to a second image at the ISP;
while receiving the first image data and the second image data, processing the first image data and the second image data at the ISP; and
in response to receiving a last portion of the first image data, delaying flushing of the first image data from an internal buffer of the ISP while processing the second image data.

19. The method of claim 18, wherein delaying flushing of the first image data from the internal buffer comprises flushing the first image data from the internal buffer in a time-interleaved manner.

20. The method of claim 18, wherein delaying flushing of the first image data from the internal buffer comprises:
predicting periods for processing of the second image data; and
flushing the first image data from the internal buffer between the periods for processing of the second image data.

21. The method of claim 18, wherein delaying flushing of the first image data from the internal buffer comprises:
observing time slots during which the second image data is received and processed;
predicting time slots for processing of the second image data based on the observed time slots; and
flushing the first image data from the internal buffer between the predicted time slots for processing of the second image data.

22. The method of claim 18, wherein delaying flushing of the first image data from the internal buffer comprises:
observing time slots during which the first image data is received and processed;
determining time slots for processing of the first image data based on the observed time slots; and
in response to receiving a last portion of the first image data, flushing the first image data from the internal buffer during the time slots for processing of the first image data.

23. The method of claim 18, wherein delaying flushing of the first image data from the internal buffer comprises:
observing an incoming data rate at which the second image data is received; and
flushing the first image data from the internal buffer at a flushing data rate that is based on the incoming data rate.

24. The method of claim 18, wherein delaying flushing of the first image data from the internal buffer comprises:
observing an incoming data rate at which the first image data is received; and
flushing the first image data from the internal buffer at a flushing data rate that is based on the incoming data rate.

25. The method of claim 18, wherein:
receiving the first image data comprises receiving the first image data one portion at a time;
receiving the second image data comprises receiving the second image data one portion at a time;
portions of the second image data are received between portions of the first image data;
processing the first image data and the second image data comprises:
in response to receiving a portion of the first image data:
storing the portion of the first image data with one or more previously-received portions of the first image data in a first internal buffer;
processing the portion of the first image data and the one or more previously-received portions of the first image data; and
outputting a processed portion of the first image data; and
in response to receiving a portion of the second image data:
storing the portion of the second image data with one or more previously-received portions of the second image data in a second internal buffer;
processing the portion of the second image data and the one or more previously-received portions of the second image data; and
outputting a processed portion of the second image data; and
delaying flushing of the first image data from the internal buffer of the ISP while processing the second image data comprises:
in response to receiving the last portion of the first image data:
processing the last portion of the first image data and the one or more previously-received portions of the first image data;
outputting a respective processed portion of the first image data for each of the last portion of the first image data and the one or more previously-received portions of the first image data; and
delaying between outputting each of the respective processed portions of the first image data by a duration related to processing a portion of data.

26. The method of claim 18, further comprising: buffering the second image data while flushing of the first image data from the internal buffer of the ISP.

27. A method for processing image data, the method comprising:
receiving first image data related to a first image at an image-signal processor (ISP);
receiving second image data related to a second image at the ISP;
while receiving the first image data and the second image data, processing the first image data and the second image data at the ISP; and
in response to receiving a last portion of the first image data, buffering the second image data while flushing the first image data from an internal buffer of the ISP.

28. The method of claim 27, wherein buffering the second image data comprises storing received second image data while the first image data is flushed from the internal buffer of the ISP and processing the received second image data after the first image data is flushed from the internal buffer of the ISP.

29. The method of claim 27, further comprising:
in response to receiving a last portion of the first image data, flushing the first image data from the internal buffer of the ISP;
while flushing the first image data, receiving second image data at a buffer;
storing the second image data received while flushing the first image data at the buffer;
after flushing the first image data, providing the second image data received while flushing the first image data from the buffer to the ISP; and
processing the second image data received while flushing the first image data.

30. The method of claim 27, further comprising delaying flushing of the first image data from in an internal buffer of the ISP while processing the second image data.
